(19) United States
(12) Patent Application Publication
(10) Pub. No.: US 2021/0120899 A1
(43) Pub. Date: Apr. 29, 2021

(54) LAMP FOR EYELASH EXTENSIONS

(71) Applicant: Margarita ZIMMER, Lubeck (DE)

(72) Inventor: Margarita ZIMMER, Lubeck (DE)

(21) Appl. No.: 17/075,936

(22) Filed: Oct. 21, 2020

(30) Foreign Application Priority Data
Oct. 25, 2019 (EP) 19205510.1

(51) Int. Cl. A41G 5/02; A45D 44/00

(52) U.S. Cl. CPC A41G 5/02; A45D 2200/10; A45D 44/00

(57) ABSTRACT

The present invention relates to a use of a lamp (1) for curing a photocurable adhesive during the extension of eyelashes, wherein the lamp (1) comprises at least one illuminant (2) and a voltage supply (3) and the lamp (1) can be controlled by a foot-operable switch (4). The present invention furthermore relates to a corresponding lamp and to a corresponding method for extending eyelashes.

The present invention relates to a use of a lamp (1) for curing a photocurable adhesive during the extension of eyelashes, wherein the lamp (1) comprises at least one illuminant (2) and a voltage supply (3) and the lamp (1) can be controlled by a foot-operable switch (4). The present invention furthermore relates to a corresponding lamp and to a corresponding method for extending eyelashes.

Eyelashes are particularly important for aesthetic appearance. Especially for women, long, thick, full-bodied and curved eyelashes are regarded as particularly aesthetic, and they are a widespread beauty ideal for many women. Many methods are known for enhancing eyelashes. One of the older methods for enhancing eyelashes is to use mascara to emphasize, color, lengthen and thicken eyelashes. The mascara is applied to the eyelashes with a brush and remains there until it is removed —usually in the evening. By adding artificial silk fibers or nylon fibers to the mascara, the optical effect of an actual eyelash extension and an increased eyelash volume are likewise obtained. Mascara, however, has the disadvantage that it is not always water-resistant and may become smudged—for example during sport or when rubbing the eye. Furthermore, it is often necessary to touch up the application of mascara regularly, and it is necessary to remove the mascara before going to bed, which in turn means that application again the next day is necessary.

As an alternative to mascara, eyelash extension has been developed. Eyelash extension is a cosmetic method in which one or more extension eyelashes, which comprise artificial or natural hairs, are respectively bonded with an adhesive to a natural eyelash in order to increase the length and fullness of the natural eyelashes and to cause increased eyelash curvature. The adhesively bonded extension eyelashes remain permanently on the natural eyelashes and usually fall out with them at the end of the natural lifetime of the eyelashes, or when the adhesive effect of the adhesive ceases. In contrast to mascara, in the case of eyelash extension, removal in the evening and reapplication in the morning are avoided, and smudging is prevented.

Cyanoacrylate adhesives, which are also known as superglues, are conventionally used as adhesives for eyelash extension. A disadvantage with the use of cyanoacrylate adhesives is that irritation or allergic reactions often occur, which may leave to itchy, reddened or irritated eyes and eye regions of the person whose eyelashes have been extended. For a beautician carrying out eyelash extension with cyanoacrylate adhesives, chronic irritations of the mucous membranes and the respiratory organs may occur since she is often exposed to the emissions of cyanoacrylate adhesives daily and for several hours.

In order to avoid this disadvantage resulting from cyanoacrylate adhesives, photocurable adhesives, which do not contain cyanoacrylates and which are cured by exposure to light of a particular wavelength, are being used more and more often. Unlike cyanoacrylate adhesives, for photocurable adhesives it is therefore necessary to irradiate the adhesive after application with light of a wavelength adapted to the adhesive, or with a corresponding wavelength range, in order to initiate the curing process of the adhesive.

The beautician conventionally uses two tweezers for the eyelash extension, which she holds in each hand. One tweezer is used to separate the natural eyelashes by pushing the adjacent eyelashes to the side. With the second tweezer, she picks up an artificial eyelash, dips one end of the artificial eyelash in an adhesive and places the eyelash wetted with the adhesive on the separated eyelash. In order to cure the photocurable adhesives, the adhesive must be irradiated with light of a suitable wavelength. In this case, the eyelash to be extended is still held separate from the adjacent eyelashes while the artificial eyelash is fixed, until the adhesive is cured. There are currently no suitable solutions for controlling the light exposure.

WO 2016/179024 A1 describes an apparatus for irradiating a photocurable adhesive, which comprises a tweezer and a lamp. The lamp is positioned over an arch applied to the end of the tweezer in such a way that it is arranged over the closed tip of the tweezer. With the tweezer, the artificial extension eyelash can be picked up, wetted with adhesive and subsequently placed on the eyelash to be extended. The lamp is controlled by means of a microprocessor and is turned on when a switch fitted on the tweezers is actuated.

US2005063177 describes an illumination arrangement which can be fitted on conventional tools, including for example tweezers. The working region is intended to be illuminated by the described illumination arrangement so as to allow the user to work accurately even in a dark environment. In this case, the light can be turned on and off by means of a control unit, constant light being provided throughout the entire working time. The curing of an adhesive with the illumination arrangement disclosed in this document is not described.

A disadvantage with the hitherto known solutions is that the weight of the tweezer is increased significantly by the illumination unit. Since the eyelashes have to be adhesively bonded individually during eyelash extension, the use of such a tweezer leads to rapid fatigue of the beautician. Furthermore, with the solutions hitherto proposed in the prior art, it is not easy to control the irradiation with light while continuing to hold the tweezers steady in the hands.

It was an object of the present invention to provide a possibility by which the disadvantages described above may be avoided. In particular, the use of a heavy tweezer is intended to be avoided and it is intended that controlling of the light can be carried out easily.

This object is achieved according to the invention by a use of a lamp (1) for curing an adhesive during the extension of eyelashes, wherein the lamp (1) comprises at least one illuminant (2) and a voltage supply (3) and the lamp (1) can be controlled by a foot-operable switch (4).

A further aspect of the present invention is a lamp (1) for curing an adhesive during the extension of eyelashes, comprising an illuminant (2) and a voltage supply (3) and/or a connection for a voltage supply (3), the lamp (1) having a foot-operable switch (4) which is configured in such a way that the illuminant (2) can be controlled by the switch (4).

It has been found that the use of a foot-operable switch (4), which may be a foot pedal switch, provides the possibility that the beautician can control the lamp with her foot and therefore can continue to use her hands to extend the eyelashes. In this way, it is also possible that the light emission time can be minimized and irradiation of the person on whom the eyelash extension is carried out can thus be minimized. The beautician may start the illumination with her foot when the artificial eyelash is applied on the eyelash to be extended with the photocurable adhesive. The irradiation ends after a set time or when the beautician releases the switch (4).

According to the invention, it is preferred for the lighting duration of the illuminant to be controlled directly by means of the foot-operable switch, i.e. the beautician controls the lamp directly by means of the switch, the lamp is turned on as soon as the beautician actuates the switch and the lamp is turned off as soon as the beautician releases the switch.

The foot-operable switch (4) is preferably configured in such a way that it can be placed on the floor.

It is to be understood that the individual components are connected to one another in such a way that current can be delivered to the illuminant from the voltage supply and the current can be controlled by means of the switch. Corresponding possibilities for cabling and control are known to the person skilled in the art.

The switch (4) may be a button which sends a pulse to a microprocessor or to a relay and therefore triggers a predetermined and optionally adjustable illumination time. The use of a microprocessor which controls the illuminant provides the possibility that different switching programs may be programmed and selected by means of a possible control unit. In this way, for example, it is possible to set the illumination duration, which starts after the actuation of the button and ends automatically after the illumination duration that has been set has elapsed. In this way, the illumination duration may be adjusted to different photocurable adhesives.

As an alternative, the switch may be a pushbutton, which activates the illumination by pressing on the switch and deactivates it by release. In this embodiment, the beautician has full control over the illumination duration.

In a less preferred embodiment, the switch is an on-off switch, i.e. the illumination is permanently activated after actuation of the switch and is not deactivated until the switch is actuated again.

The foot-operable switch (4) may be connected to the lamp, or to the illuminant (2) by means of a cable (5). In an alternative configuration, the switch (4) has a radio unit and can control the lamp, or the illuminant, by radio (for example by means of Bluetooth). A cable may be omitted in the case of wireless control by means of radio, infrared or the like, so that the usual disadvantages to associated with a cable are avoided.

In the scope of the present invention, in the event of doubt, the term lamp comprises all of the following: illuminant (2), switch (4) and voltage supply (3) and/or connection for a voltage supply. For this, however, the individual components do not need to be arranged in a single housing. For instance, it is preferred for the illuminant, voltage supply and switch to be installed in spatially separated parts of the lamp and connected to one another by means of cabling and/or wirelessly, for example by means of radio.

In the scope of the present invention, the term light is not restricted merely to the visible light spectrum but, besides visible light, also includes ultraviolet light (UV light), and in this case particularly UVA light (380-315 nm).

According to the invention, it is preferred for the illuminant (2) to emit light in the wavelength range of from 300 nm to 700 nm, preferably from 350 nm to 600 nm and particularly preferably from 380 nm to 500 nm. In this case, it is possible either that a light spectrum with light of different wavelengths is emitted or that light with only one or a few wavelengths is emitted.

According to the invention, it is particularly preferred for the illuminant to emit UVA light in the wavelength range of from 320 to 400 nm. UVA light is highly energetic, and many photocurable adhesives are configured in such a way that they can be cured with UVA light.

According to the invention, it is preferred for the illuminant (2) to be a light-emitting diode (LED). Light-emitting diodes (LEDs) are light-emitting semiconductor components which emit electromagnetic radiation of different wavelengths (visible light, infrared light and UV light) when a voltage is connected in the forward direction. The wavelength depends on the semiconductor material used and the doping of the semiconductor material. Light-emitting diodes have the advantage that they are available in very small designs, scarcely emit any heat and furthermore have a high light output.

According to the invention, it is preferred that the illuminant can be dimmed in order to adjust the intensity of the emitted light to the adhesive used.

According to the invention, it is preferred for the irradiation of the adhesive to last longer than 1/300, preferably longer than 1/200 more preferably longer than 1/100 second. It is likewise preferred for the irradiation of the adhesive to take place for less than 5 seconds, preferably less than 3 seconds, more preferably less than 1.5 seconds.

According to the invention, it is preferred for irradiation of the adhesive not to be carried out with a light flash. The person skilled in the art understands a light flash as being a short light pulse whose duration lies between about 1/300 and 1/400 000 second.

In one configuration of the invention, the duration of the irradiation is controlled only by the user, and the lamp used does not have corresponding electronics with which the duration of the irradiation is regulated. The controlling of the lamp (1) is in this case carried out by means of a foot-operable switch (4), and the irradiation lasts for as long as the user keeps the switch pressed. According to the invention, it is preferred that the lamp is not controlled by means of a microcontroller and the lamp used does not have corresponding electronics with which the duration of the irradiation is regulated.

In an alternative configuration of the present invention, the duration of the irradiation of the adhesive is controlled by means of electronics, for example a microcontroller, arranged in the lamp. In this case, a first pulse takes place by the user actuating the foot-operable switch (4). Regardless of whether or not the switch is pressed again by the user, a preset and optionally adjustable illumination interval starts. The illumination interval is adjusted to the corresponding adhesive and usually lies in the range of from 1/100 to 5 seconds.

In one configuration of the present invention, the illuminant (2) is arranged at the end of a flexible semirigid arm (6), which can preferably be brought into different positions by manual bending. Corresponding semirigid flexible arms are already known to the person skilled in the art and are often used for desk lamps or for reading lamps. In one preferred configuration, the flexible semirigid arm (6) may be a gooseneck (also referred to as a flex arm) or a jointed hose arm. The use of a corresponding flexible semirigid arm (6) provides the possibility of positioning the illuminant in such a way that it is arranged on the adhesive position of the eyelash to be extended and ideally does not hamper the beautician during the eyelash extension.

According to the invention, the flexible semirigid arm (6) is preferably configured to be thin and preferably has a thickness of less than 2 cm, more preferably a thickness of less than 1 cm.

In one configuration of the present invention, the lamp may be configured in such a way that it comprises a fastening possibility, preferably in order to fasten the lamp to a stool, a table, a piece of furniture, spectacles, a wrist, an upper or lower arm, a stand or a headband.

The fastening possibility may preferably be a clip, in particular a spectacle clip, a band, a cuff, in particular a wrist cuff, a hook-and-loop tape, a clamp, a screw or a screw socket.

As an alternative, the fastening possibility may be a ring which can be worn on a finger of a user. It is also possible for the fastening possibility to be a device through which several fingers of a hand may be inserted. In this way, the weight of the lamp may be distributed over different fingers.

Advantageously, the fastening possibility is a device through which three or four fingers of a hand can be inserted.

It is likewise possible that the lamp also has a plurality of fastening possibilities, so that it can be fastened to different objects.

Screw sockets are also often used for photo cameras in order to fasten them to stands or other supports. The use of a corresponding screw socket therefore provides the possibility of fastening the lamp according to the invention to a large number of holders available in the field of photography.

As an alternative, it is also possible for the lamp to be integrated directly into spectacles or a head mount.

In another configuration, the lamp is formed in such a way that it can stand on its own, for example on the floor or on a table. In this case, the lamp preferably comprises a pedestal which can be placed on the floor or on a table.

Depending on the embodiment of the lamp, according to the invention it is most preferred for the flexible semirigid arm (6) to have a length of more than 5 cm, preferably more than 7 cm, particularly preferably more than 10 cm, and in this case less than 45 cm.

In an alternative embodiment of the lamp, it is most preferred according to the invention for the flexible semirigid arm (6) to have a length of more than 45 cm, preferably more than 50 cm, particularly preferably more than 55 cm, and/or a maximum length of 100 cm, preferably less than 80 cm, more preferably less than 70 cm. It is preferred according to the invention for the flexible semirigid arm (6) to have a length in the range of from 45 to 100 cm, preferably in the range of from 50 to 80 cm, or preferably a length in the range of from 55 to 70 cm.

According to the invention, it is preferred for the flexible semirigid arm (6) of the lamp to be carried by the user in such a way that it is held on the finger of one of their hands, preferably on a finger of the hand which also holds the tweezer with which the artificial eyelash is held. According to the invention, it is preferred for the lamp to comprise a ring which can be connected to the flexible semirigid arm and can be fitted on to a finger of the user. In this way, the user can carry the lamp close to the finger during use. Instead of the ring, it is also possible to use a device which can be fitted onto several fingers of a hand of the user, for example onto three or four fingers of the user.

According to the invention, it is preferred for the voltage supply to be
a) one or more batteries,
b) one or more rechargeable batteries,

and/or
c) a power supply unit, which is preferably configured in such a way that it can be connected to the electricity supply.

It is naturally also possible to combine the above-mentioned options of the voltage supply. For instance, it is possible to use a rechargeable battery which is connected by means of a power supply unit, which is connected to the lamp by means of a plug and can charge this rechargeable battery, as the voltage supply. In the event that the rechargeable battery is discharged, the voltage supply may also take place alternatively by means of a power supply unit, while optionally charging the battery.

According to the invention, the voltage supply may be arranged spatially separated from the illuminant. In one configuration, the voltage supply is located in a housing, which is connected to the illuminant by means of a cable. As an alternative, the voltage supply may also be connected to the switch (4), which is in turn connected to the illuminant. It is also possible for the voltage supply to be integrated in the switch (2).

In a particularly preferred configuration of the present invention, the lamp (1) for curing an adhesive during eyelash extension comprises an illuminant (2), which emits light in the wavelength range of from 300 nm to 700 nm, a voltage supply (3) or a connection for a voltage supply (3), the lamp (1) having a foot-operable switch (4) and the illuminant (2) being controllable by the switch, the illuminant being or comprising at least one light-emitting diode (LED), the illuminant being arranged at the end of a flexible semirigid arm which can be brought into different positions by manual bending, and the switch (4) being a button or a pushbutton.

In this particularly preferred configuration, the switch is preferably formed as a foot pedal switch and connected by means of a cable to the illuminant or to a control unit for the illuminant.

In this case, it is advantageous in particular for the lamp to comprise a cuff which makes it possible to fasten the lamp on a wrist, upper arm or lower arm. In this case, the cuff is preferably formed in such a way that the flexible semirigid arm is fastened to the cuff.

According to the invention, it is preferred for the lamp to comprise optics for focusing the light emitted by the illuminant. In this way, the light cone of the emitted light can be focused exactly onto the position in order to cure the adhesive arranged between the eyelash to be extended and the artificial eyelash. The optics may be a single lens or an arrangement of a plurality of lenses. The optics may be configured in such a way that the focus can be adjusted or cannot be adjusted. The lens of the optics, all lenses of the optics of at least some of the lenses of the optics, are in this case preferably formed from a plastic or silicone. By using plastic or silicone, the weight of the optics may be reduced significantly, so that the lamp does not hamper the user when they need to hold it for a long time, for example because the lamp is fastened with a cuff on the wrist of the user.

According to the invention, it is preferred for a photocurable adhesive to be used during the use according to the invention. Correspondingly photocurable adhesives are already known from the prior art. Preferred according to the invention are photocurable adhesives comprising
a) at least one polyfunctional (meth)acrylate having two, three, four, five, six or more than six (meth)acrylate groups and/or a monofunctional (meth)acrylate having one (meth)acrylate group

and
b) at least one photoinitiator, which initiates a chemical reaction of the polyfunctional (meth)acrylates after exposure to light.

Preferably, the photocurable adhesive does not comprise monofunctional (meth)acrylates with only one (meth)acrylate group.

In an alternative embodiment, according to the invention it is preferred for the photocurable adhesives to comprise the following components:
a) at least one cyanoacrylate

and
b) at least one photoinitiator, which initiates a chemical reaction of the cyanoacrylate after exposure to light.

The cyanoacrylates used are in this case preferably selected in such a way that they only cure after exposure to light and curing does not take place during the processing, until they are irradiated with light.

A further aspect of the present invention relates to a method for extending eyelashes, comprising the following steps:
i) producing or providing a photocuring adhesive, preferably comprising the components a) and b) described above,
ii) producing or providing an artificial eyelash,
iii) bringing the artificial eyelash produced or provided in step ii) in contact with the adhesive produced or provided in step i), so that a part of the adhesive adheres to the artificial eyelash and wets it, preferably on a part of the artificial eyelash,
iv) bringing the artificial eyelash wetted with the adhesive in step iii) in contact with a (natural) eyelash to be extended, so that the adhesive is arranged between the eyelash to be extended and the artificial eyelash,
v) irradiating the adhesive with light from a lamp according to the invention, so that the adhesive arranged between the eyelash to be extended and the artificial eyelash is cured and the eyelash to be extended is adhesively bonded to the artificial eyelash.

According to the invention, it is preferred for the irradiation of the adhesive in step v) to last more than 1/300, preferably more than 1/200, more preferably more than 1/100 second. It is likewise preferred for the irradiation of the adhesive to take place for less than 5 seconds, preferably less than 3 seconds, more preferably less than 1.5 seconds.

According to the invention, the irradiation of the adhesive in step v) particularly preferably lasts more than 1/100 second and less than 5 seconds.

According to the invention, it is preferred for irradiation of the adhesive not to be carried out with a light flash. The person skilled in the art understands a light flash as being a short light pulse whose duration lies between about 1/300 and 1/400 000 second.

Embodiments of the invention are explained and described in more detail with reference to the appended figures, in which

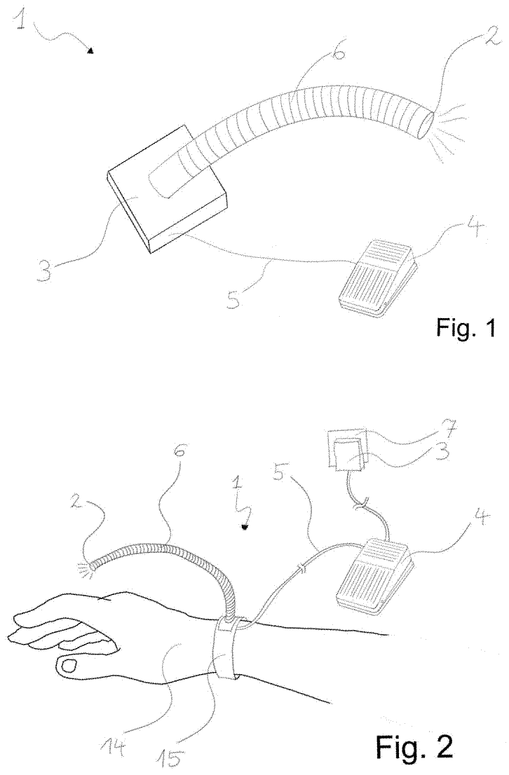

FIG. 1 shows a lamp (1) according to the invention for curing an adhesive,

FIG. 2 shows a lamp (1) according to the invention for curing an adhesive in the embodiment as a lamp which has a flexible arm (6) and is fitted on a wrist cuff (15),

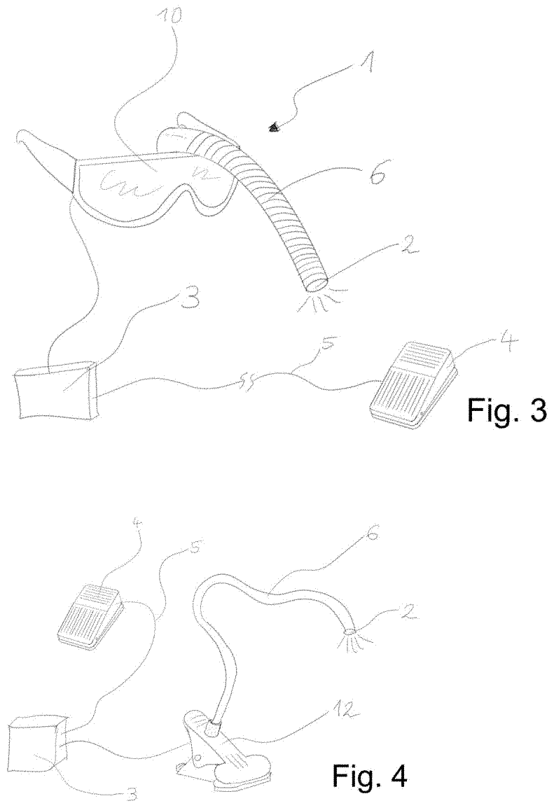

FIG. 3 shows a lamp (1) according to the invention for curing an adhesive in the embodiment as a lamp which has a flexible arm (6) and is fitted on spectacles (10),

FIG. 4 shows a lamp (1) according to the invention for curing an adhesive in the embodiment as a clamp-on lamp,

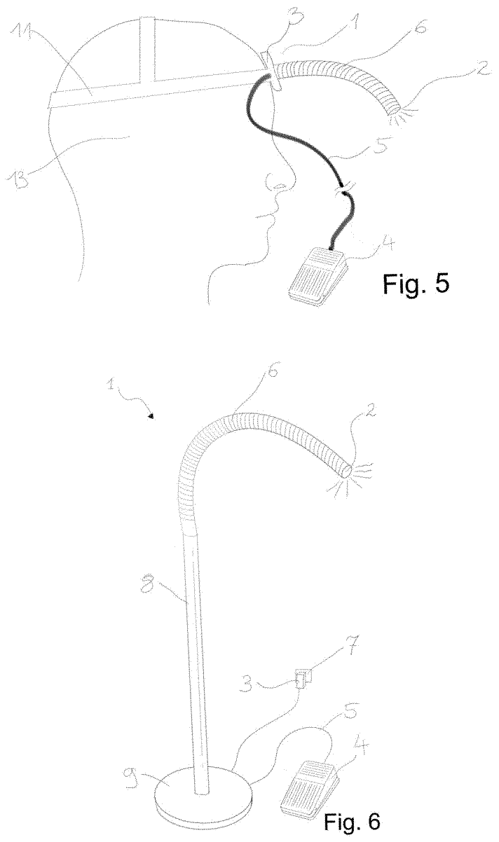

FIG. 5 shows a lamp (1) according to the invention for curing an adhesive in the embodiment as a head lamp, and

FIG. 6 shows a lamp (1) according to the invention for curing an adhesive in the embodiment as a floor lamp with a flexible arm (6).

FIG. 1 shows a lamp (1) according to the invention for curing an adhesive during the extension of eyelashes. The lamp comprises an illuminant (2, only indicated in FIG. 1), which is arranged at one end of a flexible semirigid arm (6). The arm can be brought into different positions by manual bending by the user. The arm is fitted on a housing, which at the same time constitutes a voltage supply (3) since rechargeable batteries that supply the illuminant (2), which in the present to case is a light-emitting diode that emits UVA light with a wavelength in the wavelength range of from 320 to 400 nm, with the voltage required for illumination are arranged in the housing. The lamp is connected by means of a cable (5) to a foot-operable switch (4), which in this configuration is a foot pedal switch that is formed as a pushbutton. When the operator actuates the foot pedal switch, the illuminant (2) is activated, and the illuminant is deactivated by releasing the foot pedal switch. The housing may, for example, have a fastening possibility on the rear side in order to fasten the lamp to a stool, a table, spectacles, a wrist, a headband or the like.

FIG. 2 shows a lamp (1) according to the invention for curing an adhesive during the extension of eyelashes. The lamp comprises an illuminant (2, only indicated in FIG. 1), which is arranged at one end of a flexible semirigid arm (6). The arm can be brought into different positions by manual bending by the user. In the present configuration, the arm has a length of about 20 cm, although in alternative configurations it may also have a length in the range of from 10 to 30 cm, preferably 15 to 25 cm. The flexible semirigid arm (6) is fitted on a wrist cuff (15) in order to be arranged around the wrist of a user (14). The wrist cuff may be closed by hook-and-loop fasteners. The illuminant (2) is connected by means of a cable (5) to a foot-operable switch (4), which in this configuration is a foot pedal switch that is formed as a pushbutton. When the operator actuates the foot pedal switch, the illuminant (2) is activated, and the illuminant is deactivated by releasing the foot pedal switch. The switch (4) is connected by means of a further cable to a power supply unit (3), which constitutes the voltage supply and is plugged into a wall socket (7). In this configuration, the illuminant (2) is a light-emitting diode that emits UVA light with a wavelength in the wavelength range of from 320 to 400 nm. The wrist cuff may be formed so as to be padded in order to increase the wearing comfort for the user and/or it may be formed to be as wide as possible in order to be able to distribute the pressure acting on the wrist better.

FIG. 3 shows a lamp (1) according to the invention for curing an adhesive during the extension of eyelashes, which comprises spectacles (10) for support. The lamp furthermore comprises an illuminant (2, only indicated in FIG. 3), which is arranged at one end of a flexible semirigid arm (6). The other end of the flexible arm (6) is fastened to the spectacles (10) by means of a holding device. The arm can be brought into different positions by manual bending by the user. The voltage supply (3) is carried out by means of batteries, which are arranged in a housing, and is connected by means of a cable to the spectacles and to the illuminant (2). In order to minimize the weight of the spectacles (10) with the arm (6) and the illuminant (2), it is advantageous to arrange the voltage supply (3) separately from the spectacles (10). The beautician may in this case carry the housing with the voltage supply in a pocket. The lamp is connected by means of a second cable (5) to a foot-operable switch (4), which in this configuration is a foot pedal switch that is formed as a pushbutton. When the operator actuates the foot pedal switch, the illuminant (2) is activated, and the illuminant is deactivated by releasing the foot pedal switch. The illuminant to (2) is in the present case a light-emitting diode that emits UVA light with a wavelength in the wavelength range of from 320 to 400 nm.

FIG. 4 shows a lamp (1) according to the invention for curing an adhesive during the extension of eyelashes, which comprises a clamp (12). With the clamp, the lamp may be fixed on a table, a stool or other objects or pieces of furniture. The lamp furthermore comprises an illuminant (2, only indicated in FIG. 4), which is arranged at one end of a flexible semirigid arm (6). The other end of the flexible arm (6) is fastened to the clamp (12) by means of a holding device. The arm (6) can be brought into different positions by manual bending by the user. The voltage supply (3) is carried out by means of batteries, which are arranged in a housing, and is connected by means of a cable to the illuminant (2). The lamp is connected by means of a second cable (5) to a foot-operable switch (4), which in this configuration is a foot pedal switch that is formed as a pushbutton. When the operator actuates the foot pedal switch, the illuminant (2) is activated, and the illuminant is deactivated by releasing the foot pedal switch. The illuminant (2) is in the present case a light-emitting diode that emits UVA light with a wavelength in the wavelength range of from 320 to 400 nm.

FIG. 5 shows a lamp (1) according to the invention according to FIG. 1, which comprises a headband (11) on the rear side of the housing which contains the voltage supply (3), this headband making it possible to fasten the lamp (1) on the head (13) of a user. In an alternative embodiment, the voltage supply is fitted not in the housing but in a separate housing, which may be arranged either on a part of the headband (11) resting on the back of the user's head or in a pocket of the user. By spatial separation of the lamp part that comprises the illuminant from the voltage supply (3), the weight bearing on the head of the user can be reduced. In an alternative embodiment, the voltage supply may be connected to the switch (2), which is in turn connected to the illuminant.

FIG. 6 shows a lamp (1) according to the invention for curing an adhesive during the extension of eyelashes. The lamp comprises an illuminant (2, only indicated in FIG. 6), which is arranged at one end of a flexible semirigid arm (6). The arm can be brought into different positions by manual bending by the user. The arm is arranged by means of a pole (8) on a base pedestal (9).

The voltage supply (3) is carried out by means of a power supply unit, which is plugged into a wall socket (7) and is connected to the lamp by means of a cable. The lamp is connected by means of a second cable (5) to a foot-operable switch (4), which in this configuration is a foot pedal switch that is formed as a pushbutton. When the operator actuates the foot pedal switch, the illuminant (2) is activated, and the illuminant is deactivated by releasing the foot pedal switch. The illuminant (2) is in the present case a light-emitting diode that emits UVA light with a wavelength in the wavelength range of from 320 to 400 nm. The height of the lamp (1) is configured in such a way that the arm (4) can be guided over the shoulder of a beautician, while the lamp is arranged behind the beautician. In an alternative configuration, the voltage supply and/or the foot-operable switch may be integrated into the base pedestal (9).

### LIST OF REFERENCES

1 lamp
2 illuminant
3 voltage supply
4 foot-operable switch
5 cable
6 flexible semirigid arm
7 wall socket
8 pole
9 base pedestal
10 spectacles
11 headband
12 clamp
13 head of a user
14 hand of a user
15 wrist cuff

1. A method for extending eyelashes, comprising the following steps:
i) producing or providing a photocuring adhesive,
ii) producing or providing an artificial eyelash,
iii) bringing the artificial eyelash produced or provided in step ii) in contact with the adhesive produced or provided in step i), so that a part of the adhesive adheres to the artificial eyelash and wets it, preferably on a part of the artificial eyelash,
iv) bringing the artificial eyelash wetted with the adhesive in step iii) in contact with a (natural) eyelash to be extended, so that the adhesive is arranged between the eyelash to be extended and the artificial eyelash,
v) irradiating the adhesive with light from a lamp, so that the adhesive arranged between the eyelash to be extended and the artificial eyelash is cured and the eyelash to be extended is adhesively bonded to the artificial eyelash,
wherein the lamp (1) comprises at least one illuminant (2) and a voltage supply (3), and the lamp (1) can be controlled with a foot-operable switch (4), and wherein the illuminant (2) is arranged at the end of a flexible semirigid arm (6).

2. The method as claimed in claim 1, wherein the illuminant emits light in the wavelength range of from 300 nm to 700 nm.

3. The method as claimed in claim 1, wherein the illuminant emits light in the wavelength range of from 350 nm to 600 nm.

4. The method as claimed in claim 1, wherein the illuminant emits light in the wavelength range of from 380 nm to 500 nm.

5. The method as claimed in claim 1, wherein the illuminant emits UVA light in the wavelength range of from 320 to 400 nm.

6. The method as claimed in claim 1, wherein the photocuring adhesive comprises a cyanoacrylate and at least one photoinitiator, the photoinitiator initiating a chemical reaction of the cyanoacrylate after exposure to light.

7. The method as claimed in claim 1, wherein the switch (4) is a button or a pushbutton.

8. The method as claimed in claim 1, wherein the switch (4) is a foot pedal switch.

9. The method as claimed in claim 1, wherein the semirigid arm (6) can be brought into different positions by manual bending.

10. The method as claimed in claim 1, wherein the lamp comprises a fastening possibility, which makes it possible to fasten the lamp to spectacles.

11. The method as claimed in claim 10, wherein the fastening feature is a clip.

12. The method as claimed in claim 1, wherein the lamp comprises a fastening feature, which makes it possible to fasten the lamp to a part of the body.

13. The method as claimed in claim 1, wherein the fastening feature is a cuff.

14. The method as claimed in claim 1, wherein the voltage supply (3) is carried out a) by means of one or more batteries, b) by means of one or more rechargeable batteries c) by means of a power supply unit.

15. The method as claimed in claim 1, wherein the voltage supply (3) is carried out by means of one or more rechargeable batteries.

16. The method as claimed in claim 1, wherein the voltage supply is carried out by means of a power supply unit.

17. The method as claimed in claim 1, wherein the irradiation of the adhesive in step v) lasts more than 1/100 second and less than 5 seconds.

18. A lamp (1) for curing an adhesive during eyelash extension, comprising an illuminant (2) which emits light in the wavelength range of from 300 nm to 700 nm, a voltage supply (3) and/or a connection for a voltage supply (3), the lamp (1) having a foot-operable switch (4) and the illuminant (2) being controllable by the switch, the illuminant being or comprising at least one light-emitting diode (LED),
wherein the illuminant is arranged at the end of a flexible semirigid arm which can be brought into different positions by manual bending.

19. The lamp as claimed in claim 18, wherein the lamp comprises a cuff, which makes it possible to fasten the lamp on a wrist, upper arm or lower arm.

20. The lamp as claimed in claim 18, wherein the lighting duration of the illuminant is controlled directly by means of the foot-operable switch.
